(19) United States
(12) Patent Application Publication
(10) Pub. No.: US 2023/0067558 A1
(43) Pub. Date: Mar. 2, 2023

(54) ROAD SURFACE ESTIMATION APPARATUS, ROAD SURFACE ESTIMATION METHOD AND PROGRAM THEREOF

(71) Applicant: NIPPON TELEGRAPH AND TELEPHONE CORPORATION, Tokyo (JP)

(72) Inventors: Naoto ABE, Musashino-shi, Tokyo (JP); Hitoshi SESHIMO, Musashino-shi, Tokyo (JP)

(73) Assignee: NIPPON TELEGRAPH AND TELEPHONE CORPORATION, Tokyo (JP)

(21) Appl. No.: 17/795,649

(22) PCT Filed: Feb. 7, 2020
(86) PCT No.: PCT/JP2020/004915

§ 371 Date: Jul. 27, 2022

(51) Int. Cl. G01C 7/04

(52) U.S. Cl. CPC G01C 7/04

(57) ABSTRACT

Even when there is a plurality of road surface states within one geographical range or when there is a local road surface state, a road surface state is estimated with accuracy. Included are an aggregation unit (13, 15) that aggregates, on a per predetermined geographical unit basis, results of estimating road surface states using sensor data collected in advance for each of geographical ranges and including positional information obtained during travel of a moving object, the aggregation being based on the positional information, and an estimation unit (17) that estimates the road surface state for each of the geographical ranges and based on the estimation results aggregated by the aggregation unit.

### TECHNICAL FIELD

The present invention relates to a road surface estimation device, a road surface estimation method, and a program.

### BACKGROUND ART

There has been a technology of estimating a road surface by using sensor data and positional information each obtained by a sensor attached to a moving object or the like and associating the estimated road surface with map data or the like. In this type of technology, a proposal aiming at appropriately extracting a geographical range having insufficient sensor data required for road surface estimation is made (see, e.g., PTL 1).

### CITATION LIST

### Patent Literature

[PTL 1] Japanese Patent Application Publication No. 2018-195118

### SUMMARY OF THE INVENTION

### Technical Problem

The technology of collecting the road surface data described above may encounter such a situation in which, when a corresponding link serving as the geographical range in the map data is long, a local road surface state cannot be detected or no consideration is given to a case where there is a plurality of road surface states in the link.

The present invention has been achieved in view of actual circumstances as described above, and an object thereof is to provide a road surface estimation device, a road surface estimation method, and a program which allow a road surface state to be estimated with high accuracy even when there is a plurality of road surface states within one geographical range or when there is a local road surface state.

### Means for Solving the Problem

An aspect of the present invention includes: an aggregation unit that aggregates, on a per predetermined geographical unit basis, results of estimating road surface states using sensor data collected in advance for each of geographical ranges and including positional information obtained during travel of a moving object, the aggregation being based on the positional information; and an estimation unit that estimates the road surface state for each of the geographical ranges and based on the estimation results aggregated by the aggregation unit.

### Effects of the Invention

According to the aspect of the present invention, even when there is a plurality of road surface states within one geographical range or when there is a local road surface state, it is possible to estimate a road surface state with high accuracy.

### BRIEF DESCRIPTION OF DRAWINGS

FIG. 1 is a block diagram illustrating a schematic functional configuration of a road surface estimation device according to an embodiment of the present invention.

FIG. 2 is a diagram illustrating an operation example when correction of positional information and grouping each according to the embodiment is not performed, and a road surface state of a link is estimated.

FIG. 3 is a diagram illustrating an operation example when the correction of positional information and the grouping each according to the embodiment is performed, and the road surface state of the link is estimated.

FIG. 4 is a diagram according to the embodiment.

FIG. 5 is a diagram illustrating an example of setting of a detection priority for each of barriers according to the embodiment.

FIG. 6 is a diagram illustrating an example of setting of priorities of combinations of the barriers according to the embodiment.

### DESCRIPTION OF EMBODIMENTS

A description will be given below of an embodiment when the present invention is applied to a road surface estimation device.

[Configuration of Road Surface Estimation Device]

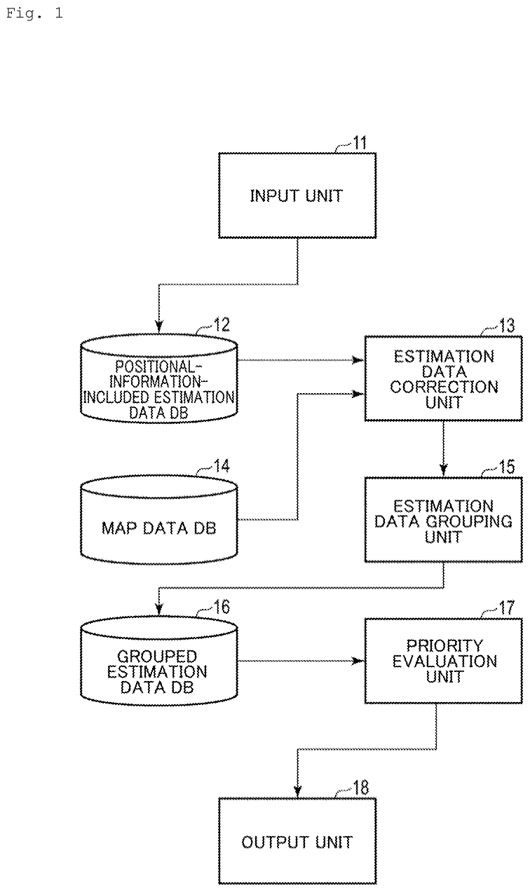

FIG. 1 is block diagram illustrating a schematic functional configuration of this road surface estimation device. In the figure, the road surface estimation device includes an input unit 11, positional-information-included estimation data DB (database) 12, an estimation data correction unit 13, a map data DB 14, an estimation data grouping unit 15, a grouped estimation data DB 16, a priority evaluation unit 17, and an output unit 18.

The input unit 11 receives, as estimation data, a data group including positional information in which a road surface state has already been estimated on a per spot basis and sensor data via a network including, e.g., the Internet. The estimation data received by the input unit 11 is stored in the positional-information-included estimation data DB 12.

The estimation data stored in the positional-information-included estimation data DB 12 is read into the estimation data correction unit 13. Into the estimation data correction unit 13, map data indicating geographical ranges (hereinafter referred to as the “links”) of a road surface involving the positional information and stored in the map data DB 14 is read.

The estimation data correction unit 13 uses the estimation data from the positional-information-included estimation data DB 12 and the map data indicating the links from the map data DB 14 to correct the positional information in the estimation data and outputs the estimation data after the positional information was corrected to the estimation data grouping unit 15.

The estimation data grouping unit 15 performs, on the estimation data including the corrected positional information, grouping of consecutive estimation data for each of preset geographical units in each of the links, e.g., for each of distances N, and determines a representative road surface state. The grouped estimation data are output to the grouped estimation data DB 16 to be stored therein.

On the estimation data stored in the grouped estimation data DB 16, the priority evaluation unit 17 performs evaluation according to the frequencies of occurrence of road surface states and to preset priorities based on combinations thereof. Thus, the priority evaluation unit 17 estimates a correct road surface state. The priority evaluation unit 17 outputs, as an estimation result, one road surface state for each one of the links to the output unit 18. The output unit 18 outputs the estimation result obtained from the priority evaluation unit 17 via the network including, e.g., the Internet.

[Operation of Road Surface Estimation Device]

Next, a description will be given of an operation in the present embodiment.

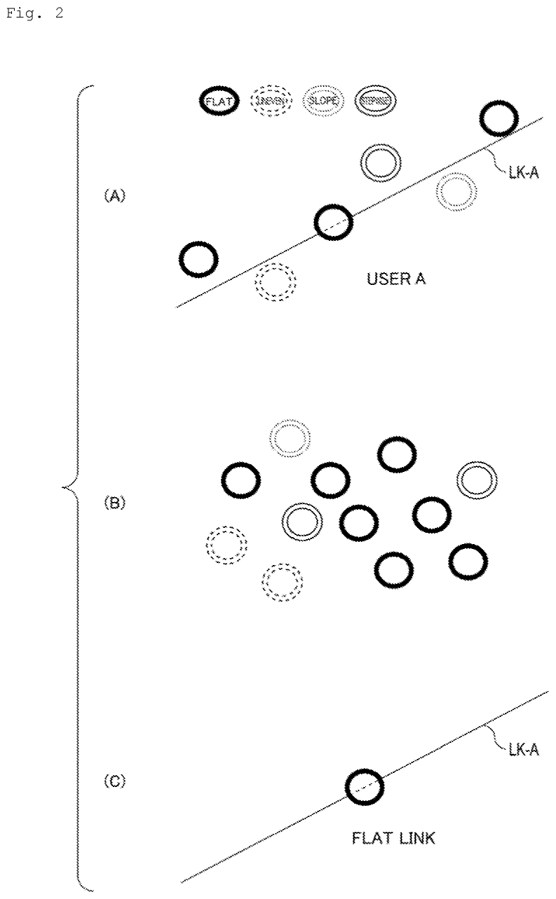

First, for the purpose of reference, referring to FIG. 2, a description will be given of an operation in a case in which the correction of the positional information, the grouping, and the priority evaluation each according to the present embodiment is intentionally not performed, and a road surface state of the link is estimated.

FIG. 2(A) illustrates an example of estimation data obtained when a user A travels a link LK-A. As illustrated in the figure, the figure (A) illustrates an example of the estimation data in which there are four road surface states “FLAT”, “UNEVEN”, “SLOPE”, and “STEPWISE” at individual spots.

FIG. 2(B) illustrates an example of a result of integrating all the estimation data related to the link LK-A. Of a total of twelve spots, the seven spots have the road surface state “FLAT”, the two spots have the road surface state “UNEVEN”, the one spot has the road surface state “SLOPE”, and the two spots have the road surface state “STEPWISE”.

FIG. 2(C) illustrates a result of estimating the road surface state representing the link LK-A serving as the geographical range to be “FLAT”, which results from direct overall evaluation of the road surface states illustrated in FIG. 2(B) and integration of evaluation results.

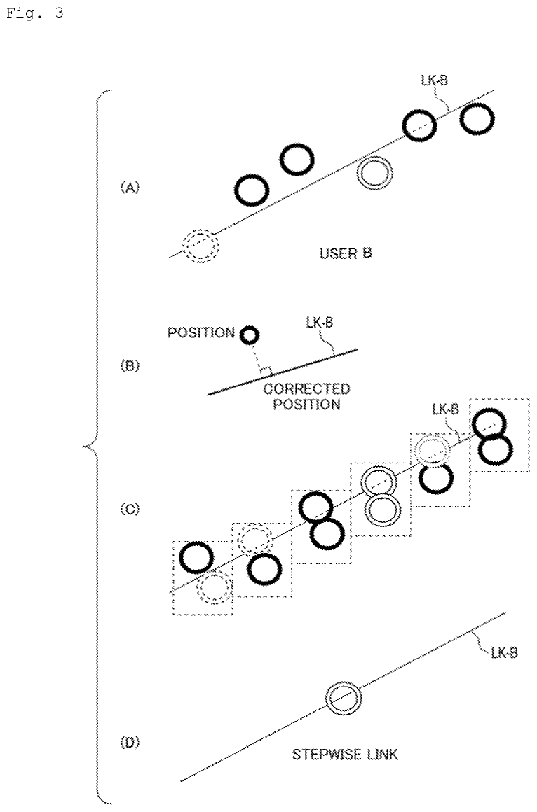

Next, referring to FIGS. 3 to 6, an operation in the road surface estimation device according to the present embodiment will be described.

FIG. 3 is a diagram illustrating an operation example when the correction of the positional information, the grouping, and the priority evaluation is performed, and the road surface state of the link is estimated.

FIG. 3(A) illustrates an example of estimation data obtained when a user B travels a link LK-B. As illustrated in the figure, the figure (B) also illustrates the example of the estimation data in which there are the four road surface states “FLAT”, “UNEVEN”, “SLOPE”, and “STEPWISE” at individual spots. Such estimation data is received by the input unit 11 via the network and then stored in the positional-information-included estimation data DB 12.

The estimation data correction unit 13 performs position correction processing of correcting, based on the estimation data stored in the positional-information-included estimation data DB 12 and the map data stored in the map data DB 14, positional data in the estimation data in accordance with a nearest link.

FIG. 3(B) is a diagram for illustrating a method for the position correction processing to be performed by the estimation data correction unit 13. The estimation data correction unit 13 calculates, for a spot position in the estimation data, a spot at which a perpendicular line drawn therefrom to the nearest link LK-B as the corrected positional information, and rewrites the positional information in the estimation data.

By thus correcting the positional information, on the estimation data having increased continuity in the link LK-B serving as a travel path, the grouped estimation data DB 16 performs collection and grouping of consecutive estimation data for each of preset geographical units in the link, e.g., for each of the distances N (N is a constant), determines a road surface state representing the grouped estimation data, and then outputs the determined road surface state to the grouped estimation data DB 16 such that the output road surface state is stored therein.

It is widely known that, in, e.g. a typical GPS (Global Positioning System), a position error occurs on the order of meters in the positional information. Accordingly, by performing such correction processing as to increase the continuity along the travel path on positional information as described above, it is possible to accomplish grouping with higher accuracy.

FIG. 3(C) illustrates an example in which the estimation data grouped by using the corrected positional information are collected and grouped for each of the distances N of the link LK-B. The ROM 15 aggregates the results of estimating the road surface states in the estimation data for each of the groups resulting from the collection to make a determination and stores a result of the determination in the grouped estimation data DB 16.

Note that a method for obtaining the result of the determination made by aggregating the road surface states for each of the groups is described in, e.g., the paragraph [0068] in PTL 1 described above.

The priority evaluation unit 17 performs evaluation on the estimation data stored in the grouped estimation data DB 16 based on the result of determining the road surface state of each of the groups and according to the frequencies of occurrence of the road surface states in the entire link and to priorities based on combinations thereof to estimate a correct road surface state of the link LK-B.

FIG. 3(D) illustrates a result of estimating the road surface state of the link LK-B to be “STEPWISE”. The output unit 18 outputs the result of the estimation via, e.g., a network not shown.

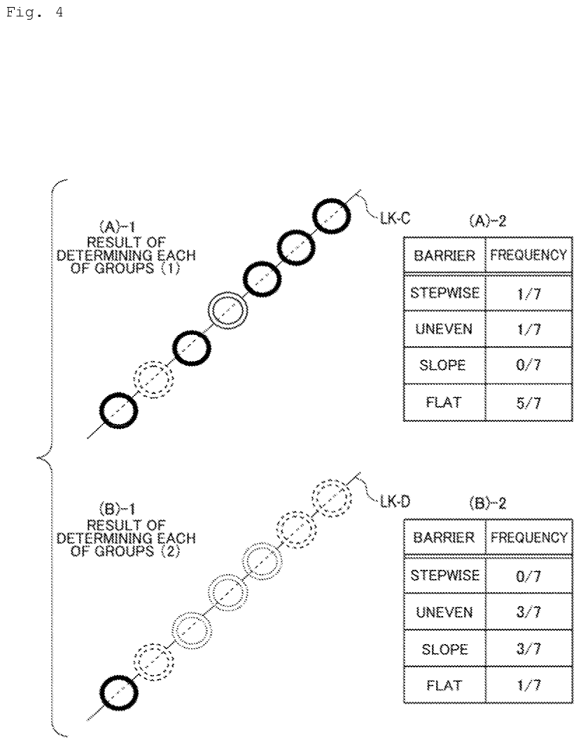

Next, referring to FIGS. 4 to 6, a description will be given of specific details of processing of priority evaluation by the priority evaluation unit 17.

FIG. 4(A)-1 is a diagram illustrating an example of a result of determining the road surface state of each of the groups obtained by grouping the estimation data of the road surface states which are obtained from a user having traveled a link LK-C. FIG. 4(A)-2 illustrates a result of collecting, as frequencies of occurrence, results of determination (barriers) of the road surface states representing the individual groups for the individual distances N.

Here, the frequency of occurrence of the barrier “STEPWISE” is “1/7 (0.143)”, the frequency of occurrence of the barrier “UNEVEN” is “1/7 (≈0.143)”, the frequency of occurrence of the barrier “SLOPE” is “0/7”, and the frequency of occurrence of the barrier “FLAT” is “4/7 (0.571)”.

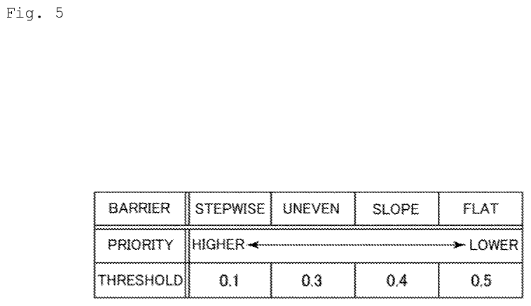

The priority evaluation unit 17 detects, based on thresholds of detection priorities illustrated in FIG. 5, the barriers exceeding the individual thresholds. It is assumed that the thresholds for the individual barriers illustrated in FIG. 5 can freely be set by an operator of the road surface estimation device.

The respective frequencies of occurrence of the barrier “STEPWISE” and the barrier “FLAT” are exceeding the set thresholds herein and, based on the detection priorities described above, it is determined that “STEPWISE” and “FLAT” are exceeding the preset frequencies of occurrence.

Next, the priority evaluation unit 17 determines that, when there is one barrier having exceeded the set frequency of occurrence, the barrier is the result of estimating the road surface state of the entire link while, when there are two barriers having exceeded the set frequencies of occurrence, a barrier derived from a combination of the barriers is the result of estimating the road surface state of the entire link.

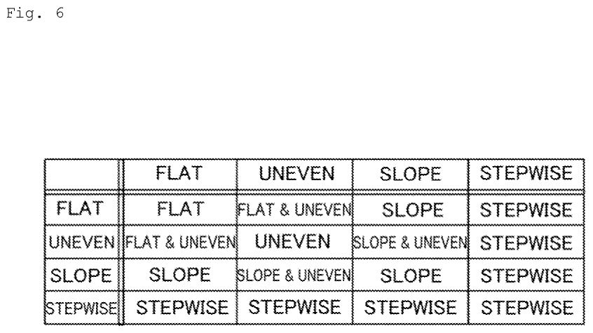

FIG. 6 is a diagram illustrating an example of setting of the priorities based on combinations of the barriers. It is set that, as a result of combining the two barriers “STEPWISE” and “FLAT”, the road surface state of the entire link is determined to be the one barrier “STEPWISE”, and accordingly it is calculated that the result of estimating the road surface state of the link LK-C is “STEPWISE” by the priority evaluation in the priority evaluation unit 17, and “STEPWISE” is output by the output unit 18.

FIG. 4(B)-1 is a diagram illustrating an example of a result of determining the road surface state of each of the groups obtained by grouping the estimation data of the road surface states which are obtained from a user having traveled a link LK-D. FIG. 4(B)-2 illustrates a result of collecting, as frequencies of occurrence, results of determination (barriers) of the road surface states representing the individual groups for the individual distances N.

Here, the frequency of occurrence of the barrier “STEPWISE” is “0/7”, the frequency of occurrence of the barrier “UNEVEN” is “3/7 (0.429)”, the frequency of occurrence of the barrier “SLOPE” is “3/7 (0.429)”, and the frequency of occurrence of the barrier “FLAT” is “1/7 (0.143)”.

The priority evaluation unit 17 detects, based on the thresholds of the detection priorities illustrated in FIG. 5, the barriers exceeding the individual thresholds. The frequencies of occurrence of the barrier “UNEVEN” and the barrier “SLOPE” are exceeding the set thresholds herein and, based on the detection priorities described above, it is determined that “UNEVEN” and “SLOPE” are exceeding the preset frequencies of occurrence.

Next, the priority evaluation unit 17 determines that, when there is one barrier having exceeded the set frequency of occurrence, the barrier is the result of estimating the road surface state of the entire link while, when there are two barriers having exceeded the set frequencies of occurrence, a barrier derived from a combination of the barriers is the result of estimating the road surface state of the entire link.

FIG. 6 is a diagram illustrating an example of setting of the priorities based on the combinations of the barriers. It is set that, as a result of combining the two barriers “UNEVEN” and “SLOPE”, the road surface state of the entire link is determined to be the two barriers “SLOPE & UNEVEN”, and accordingly the priority evaluation unit 17 calculates that the result of estimating the road surface state of the link LK-D is “SLOPE & UNEVEN” by the priority evaluation, and “SLOPE & UNEVEN” is output as a final result of estimating the road surface by the output unit 18.

[Effects]

As has been described above in detail, according to the present embodiment, even when there is a plurality of road surface states in one geographical range or when there is a local road surface state, it is possible to estimate a road surface state with high accuracy.

Also, in the present embodiment, it is assumed that the road surface state is estimated for each of the links from the grouped estimation results based on the frequencies of occurrence and the predetermined priorities of the combinations of the results of estimating the individual road surface states. Accordingly, it is possible to freely vary setting of a criterion for final estimation and easily calculate an overall estimation result from the plurality of estimation results.

Note that, in the present embodiment, the description has been given, by way of example, of the case where the road surface states are classified into the four categories “FLAT”, “UNEVEN”, “SLOPE”, and “STEPWISE”, but the present invention is not limited thereto.

Besides, the invention in the present application is not limited to the embodiment described above, and various modifications can be made within a scope not departing from the gist thereof when the present invention is implemented. Furthermore, the embodiment described above includes inventions at various stages, and various inventions can be extracted by appropriately combining a plurality of disclosed constituent elements. For example, even when some constituent elements are omitted from all constituent elements shown in the embodiment, a configuration obtained by omitting these constituent elements can be extracted as an invention so long as the problems described in Technical Problem can be solved and the effects described in Effects of the Invention can be achieved.

### REFERENCE SIGNS LIST

11 Input unit
12 Positional-information-included estimation data DB
13 Estimation data correction unit
14 Map data DB
15 Estimation data grouping unit
16 Grouped estimation data DB
17 Priority evaluation unit
18 Output unit
LK-A to LK-D Links (Geographical ranges)

1. A road surface estimation device comprising:
a processor; and
a storage medium having computer program instructions stored thereon, when executed by the processor, perform to:
aggregates, on a per predetermined geographical unit basis, results of estimating road surface states using sensor data collected in advance for each of geographical ranges and including positional information obtained during travel of a moving object, the aggregation being based on the positional information; and
estimates the road surface state for each of the geographical ranges and based on the estimation results aggregated by the aggregation unit.

2. The road surface estimation device according to claim 1, wherein the computer program instructions further perform to corrects the positional information based on continuity of a travel path in the geographical range and aggregates, based on the corrected positional information and on the per predetermined geographical unit basis, the results of estimating the road surface state using the sensor data including the positional information.

3. The road surface estimation device according to claim 1, wherein the estimation unit estimates the road surface state for each of the geographical ranges and based on at least either one of priorities of frequencies of occurrence of the aggregated estimation results and predetermined priorities of combinations of the results of estimating the individual road surface states.

4. A road surface estimation method comprising:
a first estimation step of estimating road surface states from sensor data collected in advance for each of geographical ranges and including positional information obtained during travel of a moving object;
an aggregation step of aggregating, based on the positional information and on a per predetermined geographical unit basis, results of estimating the road surface states in the first estimation step; and
a second estimation step of evaluating, for each of the geographical ranges and based on the aggregated estimation results, the road surface state of each of the geographical ranges.

5. A non-transitory computer-readable medium having computer-executable instructions that, upon execution of the instructions by a processor of a computer, cause the computer to function as the road surface estimation device according to claim 1.
